(19) United States
(12) Patent Application Publication
(10) Pub. No.: US 2008/0036615 A1
(43) Pub. Date: Feb. 14, 2008

(54) Automated level indicator for liquids container

(76) Inventor: Lucian Hite Lyall III, Rancho Santa Margarita, CA (US)

Correspondence Address: Harrington & Harrington;Curtis L. Harrington, Suite 250, 6300 State University Drive, Long Beach, CA, 90815, US

(21) Appl. No.: 11/881,454

(22) Filed: Jul. 27, 2007

Related U.S. Application Data
(63) Continuation-in-part of application No. 10/917,883, filed on Aug. 13, 2004.

(51) Int. Cl. G01F 23/14

(52) U.S. Cl. 340/614

(57) ABSTRACT

An improved level indicator is provided as a completed dispensing unit or as a retrofit and includes the capability for measuring liquid level, time elapsed, temperature, two-phase presence within the drainage pipe for very accurate level sensing, as well as the ability to set combinational limits based upon any of the above measured characteristics. An indicator can visually indicate to food service workers the state of the liquid being dispensed.

This application is a continuation-in-part application of co-pending U.S. Pat. No. 10/917,883 filed Aug. 13, 2004.

### FIELD OF THE INVENTION

The present invention relates to the field of liquid level sensing, and more particularly to liquid level sensing for non hazardous, non-corrosive materials, and specifically to level indicators used in food service equipment.

### BACKGROUND OF THE INVENTION

The standard for level indication equipment has for years been the sight glass. Sight glasses are visible channels, typically tubes, which share part of the volumetric capacity of a vessel and which occupy a level in the visible channel the same as the liquid inside the main vessel. Sight glasses have always had operating limitations that the fittings securing the glass must not leak, that the fittings and glass should be able to be secured tightly enough to withstand the pressure inside the vessel.

Food service vessels typically utilize large round sight glasses having a lower end connected to open into the bottom and an upper end connected into the top of a main liquid reservoir. The liquid level in the sight glass will match the level in the reservoir as gravity pulls on both liquid columns the same. It is not often realized the rough treatment that such vessels undergo during a typical day of usage. Workers are often not strong enough to supply the strength and acumen necessary to treat a heavy vessel with adequate care. A broken sight glass can result in spillage of contents on carpeting, often creating a coffee stain requiring specialized cleanup. Breakage of sight glasses also poses a danger to nearby occupants. Further, a rising number of incidents have been observed where the glass tubes may be intentionally broken by workers to obtain it for recreational drug use. Sight glasses cannot effectively be protected by the use of cages and screens as they would drive up the equipment and maintenance cost significantly, as well as to obscure the visual determination of liquid level. Cleaning and replacement would also then be a problem as any protector would require specialized cleaning and likely removal as a pre-requisite to replacement.

Having to provide site glasses along the whole effective height of the reservoir also blocks the ability to further utilize other components with it. Insulation blankets cannot be used efficiently where they are so oversized that they cover over the sight glass and create unrestricted air pockets, while a close fitting insulation blanket cannot fit over the sight glass. Other components which are inhibited by the interruption of an even radial surface include protective sleeves, decorative sleeves, advertising, handling instructions and more.

Another problem with sight glasses is that they must typically be large to insure that enough liquid is swept through them to prevent any collection of debris which might block the sight glass tube. As such, smaller tubes or small flat plastic channels do not work well. Anything smaller than a large glass tube would likely be able to collect debris and to malfunction.

Sight indicators are important so that food service can be supplied efficiently and accurately. When food and drink reservoirs go empty, users are inconvenienced and sales are lost. When food workers change out half empty containers for filled ones to prevent outages, unused food product is lost. Likewise, hot or cold food and drink which has become room temperature will continue to inconvenience users and result in lost sales. A half reservoir of cold coffee will not be consumed despite a room full of people thirsty for coffee. In terms of overall economics, food service is primarily a service, and when service suffers, sales will suffer. Accommodation must be made to at least enable high level service providers to provide the high level of service when desired.

U.S. Pat. No. 7,000,468 issued on Feb. 21, 2006 to Doorhy et al, and incorporated by reference herein gives one example of a system using a series of vertical connections leading to a board mounted pressure sensor. The problems are several. First, there are a series of pressure fittings which multiply the ability to leak. Secondly, a column is established which has the ability to introduce error, as well as to clog. Because of the relatively large diameter column established, any inversion during cleaning can fill the established column and cause clogging of the so-called “check” valve device (which is not as much a check valve to permit flow in one direction as it is a filter.

### SUMMARY OF THE INVENTION

An improved level indicator takes advantage of the universal visual impression of typical sight glasses, but without the disadvantages of a physical sight glass protruding from the main body of the reservoir. An improved level indicator takes advantage of the universal visual impression of typical sight glasses, but without the disadvantages of a physical sight glass protruding from the main body of the reservoir. In addition, other quantities are measured, including two-phase presence in a drainage pipe, temperature of the liquid product measured against either the drain pipe or reservoir, and temporal passage. Each of the measured quantities can result in an individual visual indication, or can thresholded combinationally to provide a combined threshold limit for initiating visual indication.

A sealed unit is provided low on a food dispensing reservoir and upstream of a dispensing valve with a sensor in fluid communication with the static pressure in the dispensing valve. Because the sealed unit is in communication with the liquid in the reservoir at the lower position only, several alternatives may be utilized to equate the static pressure with the liquid level in the food service container reservoir.

First, an independent ambient pressure sensor may-be utilized. This will enable the unit to distinguish between the exact levels of fullness in Denver, Colo. at a mile high altitude versus Long Beach, Calif. at sea level. Second, a calibration routine may be performed on startup where the sensor recognizes a change in pressure equivalent to a transition from empty to full.

For example, where a reservoir, for example is filled to a height of one foot, and where water is used, the change in static pressure will be from ambient air pressure to the addition of 62.427 pounds per square foot, or 0.43 pounds per square inch (PSI). At a given temperature at sea level, the pressure is 14.696 PSI. At the same temperature one mile above sea level, the pressure may be 12.096 PSI. Yet the range over which the sensor must measure is 0.43 PSI for a one foot water column height. Higher or shorter main reservoirs 31 should have proportionately more or less resolution. In most commercial coffee containers of the type pictured in FIG. 1, a pressure measuring ability range of from about 0-28″ water column resolution is sufficient. Thus, the sensor may be programmed to measure a rapid change in pressure and to take the rapid change on fill up, rather than a measure of an a scalar absolute pressure. Thus, it will measure and give an indication of level based upon the rapid 0.43 PSI difference as its working range between an indication of full and empty.

Third, it may combine pressure sensing of the ambient air pressure in addition to sensing a pressure change on fill-up. Fourth, the sensor may store and record an average set of maximum and minimum pressure values over time to give a time average pressure range as a time average maximum pressure and a time average minimum pressure.

The sensor of the invention will also have a range of other sensing and service-out indicators. First, the sensor may include an optional “air gap” optic sensor which can be utilized in conjunction with its small elastomeric pressure tube or with a separate sealed fiber optic tube. A light pulse sent into the product tap pipe will reflectively return if the liquid level in the tap pipe is low enough to create a partially filled channel. A light impulse will be returned to the sensor if the liquid level in the tap pipe is not full, representative of the last eighth of an inch range of liquid flow. This can be used to trigger a special flashing alarm to insure that the food service workers recognize it instantly.

In addition, other indicators can be employed using the same sensor area just upstream of the drain pipe, as well as contact of the sensor with the main reservoir, including temperature. Minimum acceptable temperature of the product can be programmed. In the alternative, the sensor can be programmed to sense the initial temperature of the reservoir and to give a food service indication when it has changed to a temperature within, say 20° Fahrenheit of room temperature. Coffee, for example would begin at about 190° Fahrenheit, and when the temperature drops to say 110° Fahrenheit, an temperature indicator would light. Likewise, iced tea would begin at about 37° Fahrenheit and would give a temperature problem indication at about 60° Fahrenheit.

For even more closely managed liquid food service dispensing, a time indicator could also be used. The sensor may trigger automatically on fill by either a temperature trigger, hot or cold, or by a fill pressure trigger. The timer may be set to one time difference for initial introduction of a cold liquid and to a second time difference for initial introduction of a hot liquid, or the time may be programmed. Time indications can be important where the sensor of the invention is used with a heated vessel, and where product spoilage or lack of freshness is keyed more to passage of time than to temperature or usage rate.

In a further embodiment, the provision of an extended pressure conduit along with co-location of the sensor at the centerline of the exit shank can significantly reduce error. Further, the use of a fitting which is larger than the pressure conduit can help reduce any inadvertent errors by the ratio of the cross sectional surface area of the fitting divided by the cross sectional surface area of the fitting. The error reduction is particularly reduced over the first bit of pressure drop and before the liquid reaches the pressure conduit.

The compact version of a housing and spigot assembly is advantageous for use where a connection can be made at part of an existing exit shank, whether through fitted connection or via cutting and gluing. In some cases, a retrofit replacement can be had by leaving an existing shank and exit valve in place and tapping into the existing tank to form an upwardly extending branch over which a fitting can be sealably engaged.

### BRIEF DESCRIPTION OF THE DRAWINGS

The invention, its configuration, construction, and operation will be best further described in the following detailed description, taken in conjunction with the accompanying drawings in which:.

FIG. 1 is a perspective view of a food service liquid dispenser having a reservoir mounted above an integral stand and having a front tap and protector with the sensor of the present invention shown exploded from it;

FIG. 2 is a side sectional view taken along line 2-2 of FIG. 1 and illustrating the connection to the valve and drain pipe, with the pressure tap being above the drain pipe;

FIG. 3 is a closeup view of one embodiment of the display area seen in FIG. 1;

FIG. 4 is a closeup view of a housing and pipe connection, compact and advantageous for either retrofit or original installation; and

FIG. 5 is a rear view of the housing and pipe connection seen in FIG. 4.

### DETAILED DESCRIPTION OF THE PREFERRED EMBODIMENT

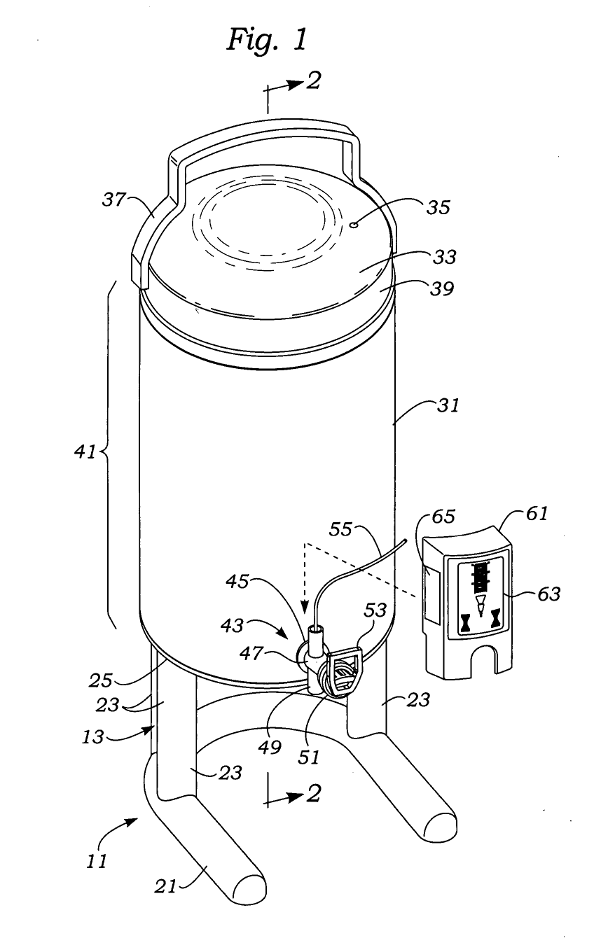

The process and apparatus described herein will in concentrate on the somewhat schematic use of a sensor in conjunction with the drain pipe of a liquid food service container upstream of the valve. Referring to FIG. 1, a generic arrangement for a food service liquid dispensing container 11 is shown as having an integrated base stand 13 which supports a vessel 15 above.

The base has a main “U” shaped support 21 to provide easy clearance for the entry of drinking cups and user access. From the main “U” shaped support 21, a series of vertical columns 23 attach to a base support 25.

A main reservoir 31 has a lid 33 with a small vent hole 35. An optional bail handle 37 is shaped to accommodate the lid 33 and folds away to enable access to the lid 33. An upper fitting 39 provides some interruption of the main cylindrical surface of the reservoir 31. A cylindrical surface 41 is generally only interrupted by a tap 43. Tap 43 in the alternative, could have emerged from beneath the main cylindrical surface 41, such as from a point underneath the cylindrical surface 41. The arrangement of the tap can further free the lower areas of the cylindrical surface 41.

Tap 43 may have a flange fitting 45 as an expanded area of material acting a washer to spread its bearing surface onto an expanded area of cylindrical surface 41, especially where it has an insertion portion extending into the inner reservoir (not shown in FIG. 1) and secured with axial force. The tap 43 being shown is non-integrated into the remainder of the inventive sensor and indicator for familiarity and to demonstrate that the sensor and indicator can be supplied to work with existing components, or it can be supplied along with a tap 43 assembly.

Tap 43 includes a main horizontally disposed faucet shank, or drainage pipe 47 upstream of a vertical drain 49. Drain pipes need not be horizontal and may be vertical, but the configuration of FIG. 1 simply happens to have a horizontal pipe 49. A vertical pipe below a main reservoir would give a maximum vertical pressure head and would be more accurate in determining the pressure throughout a fuller height of fluid head than a horizontal tap, and particularly a tap 43 which is above the lowermost extent of a liquid level in a reservoir 31. Continuing away from the cylindrical portion 41, the horizontally disposed drainage pipe 47 includes a fitting 51 supporting an operating handle 53. A thin conduit 55 extends from the horizontally disposed drainage pipe 47 from a position upstream of the operation of the valve components within the tap 43, such that the thin conduit 55 is in fluid communication with the liquid within the main reservoir 31. Thus, the pressure may drop temporarily when the handle 53 is activated to allow liquid to flow through the vertical drain 49, but when the tap is shut, the static pressure head upstream of the valve opening will be transmittable along the conduit 55.

Further, the orientation and size of conduit 55 can prevent contact of the server media liquid with the transducer. The liquid will compress any air present in the conduit 55 tubing to form a meniscus which will not wet the walls of the conduit 55 beyond the liquid/air interface. This liquid-gas dividing line may move back and forth along the length of the conduit as varying pressure is exerted on the transducer due to changes of liquid level in the reservoir. This will allow the air-liquid interface to move, to compress the air bubble against any transducer to which it is connected, yet isolate the actual transducer from liquid contact. This “air bubble isolation” is assists the long term performance and accuracy of the transducer. This method provides for a pressure reading without a hot or cold media directly contacting the transducer die. Potting, or encasement of all components surrounding the end of the conduit 55 will further prevent leakage and contribute to the operation of this principle.

To the right and displaced from the tap 43 is an sensor housing 61 having a display area 63. Display area 63 may utilize LED's or liquid a liquid crystal display. Sensor housing 61 has a lower inverted “U” shape to help integrate the fit over the main horizontally disposed drainage pipe 47. Where the sensor housing 61 is rigidly attached directly to the main horizontally disposed drainage pipe 47, the space between the cylindrical surface 31 and the rear of the sensor housing 61 will be available for adding placards, insulating layers, or other flat materials, including signage.

The end of thin line 55 is shown free, but will be connected to the rear of the sensor housing 61, possibly into a potted volume. The additional length of thin line 55 could be provided to enable removal of the sensor housing 61, especially where removal is necessary to change a battery. In the alternative, a side battery door 65 may be provided. Further, a photo voltaic array 67 may be provided to power the electronic components within the housing 61 either alone or as a supplement to a battery located behind the battery door.

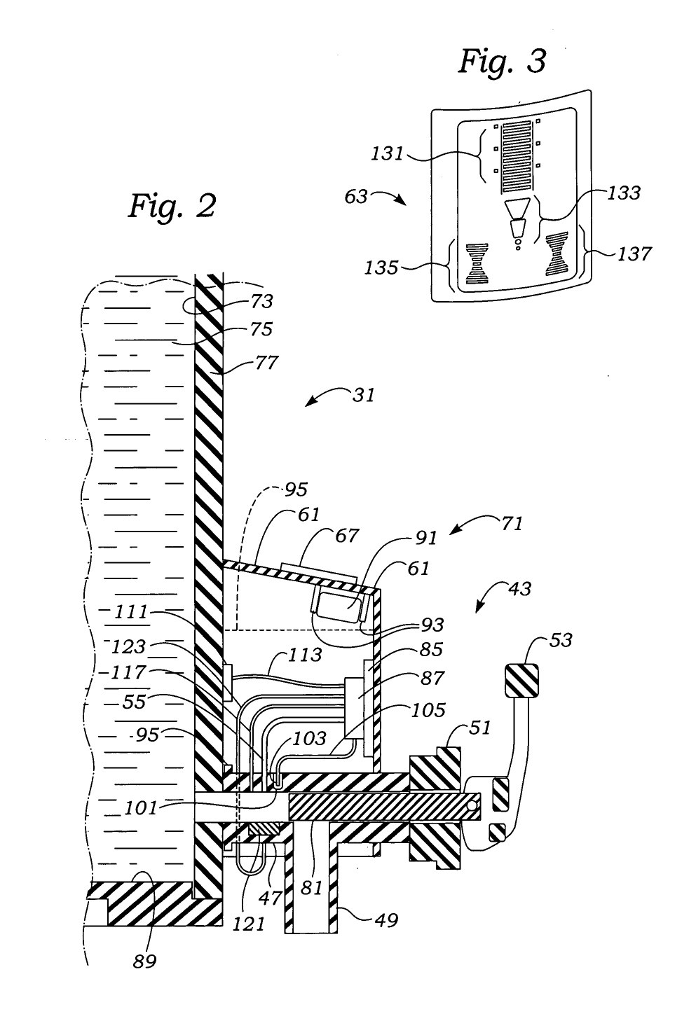

Referring to FIG. 2, a sectional view taken along line 2-2 of FIG. 1, but with the sensor housing 61 in place, reveals further details of the components assembled into an indicator system 71. Again, the indicator system 71 can be packaged with or without the associated assembly of the tap 43. From the left, an internal reservoir 73 contains a liquid 75 shown by periodic interrupted horizontal lines. In this instance, the flange fitting 45 can be seen to include a two sided structure with a matching internal flange portion embracing the effective main reservoir wall 77. The wall 77 can be made of layers of material which may include a sleeve, applied layers, or insulation layers.

Liquid 75 is seen to freely exist within the flange fitting 45 and the short length of main horizontally disposed drainage pipe 47 extending beyond the flange fitting 45. A valve sealing member 81 forms a pressure seal into an internal portion of the main horizontally disposed drainage pipe 47, just before the vertical drain 49 is accessed. In the tap 43, fitting 51 houses spring biased (spring mechanism not seen to maintain clarity of the drawing) valve sealing member 81 which is constantly biased to enter the end of the main horizontally disposed drainage pipe 47 to shut off the liquid flow.

Handle 53 is seen to attached to pivot with respect to valve sealing member 81 and any pivoting of handle 53 will cause the valve sealing member 81 to be withdrawn from sealing contact with the inside of the main horizontally disposed drainage pipe 47 to allow liquid to flow into the vertical drain 49.

In normal usage, the tap 43 and its assemblage will remain closed the vast majority of the time. Thus, the thin line 55 will be enabled to register the pressure at the main horizontally disposed drainage pipe 47, and into a circuit board 85 sensor processing circuit 87. Sensor processing circuit 87 may be a microprocessor having digital and or analog component circuitry and whose main function is to receive sensor signals and to interpret the sensor signals utilizing an instruction set and to send appropriate information to components in the display area 63, so that necessary states and indications of necessary actions to be taken can be displayed.

The location of the end of the thin line 55 should be as low as possible with regard to a bottom floor 89 of the internal reservoir 73 as is possible, so that positive pressure will be present throughout the complete range of liquid 75 level within the internal reservoir 73 as is possible. In an integrated indicator system 71, the sensor electronics may be located immediately adjacent the main horizontally disposed drainage pipe 47, preferably below or to the side.

Also seen within the sensor housing 61 is a battery 91 held between a pair of battery contacts 93. The battery 91 may be connected to the photocell 67 (connection is not shown) to supplement its power or to recharge it, or to allow battery 91 to act as backup power in dimly lit conditions. A potting line 95 is seen to illustrate that all of the components of the indicator system 71 can be potted, and or formed integrally with the tap 43 which will eliminate the need for fittings, eliminate the possibility of disconnection of the thin line 55, and eliminate any possibility of external leakage. Only the battery 91 and its battery contacts 93 need be outside the potted area. Further, the circuit board 85 and sensor processing circuit 87 may also be made to be located close to the main horizontally disposed drainage pipe 47 to further reduce the size of the indicator system 71.

In terms of temperature, an additional blind bore 101 could be provided in the main horizontally disposed drainage pipe 47 with a temperature sensor 103, such as a thermocouple connected by a wire set 105 to the circuit board 85 sensor processing circuit 87. As another example, a thermal sensor 111 can be mounted directly adjacent the main reservoir wall, and connected by a wire set 113 to the circuit board 85 sensor processing circuit 87. The accuracy of either locating a temperature sensor adjacent the main reservoir 31 or within the main horizontally disposed drainage pipe 47 will depend upon the materials of each of these structures, the degree of insulation and more.

Further, the thin line 55 can be made of an optical material. In this instance, the sensor processing circuit 87 can periodically generate a light pulse into the thin line 55. The end of the thin line 55 which terminates at the top of the main horizontally disposed drainage pipe 47 will generate a reflection if the liquid 75 has an air space over it within the main horizontally disposed drainage pipe 47, to indicate a level approaching a terminally low liquid level. In the alternative, a single, solid fiber optic line 117 can be provided directly into the main horizontally disposed drainage pipe 47 and terminating even with the internal wall of the main horizontally disposed drainage pipe 47 and perhaps polished even with the internal wall.

Fiber optics can easily work within the main horizontally disposed drainage pipe 47 to essentially detect two phase fluid. It is clear that a pipe, especially a vertical conduit cannot sense two phase pressure where the liquid level must rise vertically, to some degree above the pipe. Two phase pressure within a pipe line can only be measured by some device which can compute the level of fluid within a pipe. Pressure can be measured if a bottom tap from a pipe were made, but this is practically unworkable, unsanitary and unsafe. A bottom tap from a pipe would always leave old product in a loop extending from the bottom of the pipe to a pressure head conduit. Where the pressure is measured in a terminal pressure connection at the other end of a “U” tube, the product in the tube will always be present and will never be cleared. In this configuration, mold, germs, bacteria and mildew will be encouraged to grow within the pressure determining apparatus and can cause harm or in the alternative will create the need to completely disassemble the pressure measuring apparatus.

As a result, the measurement of two phase flow from a pressure apparatus which takes its pressure signal from the bottom of a pipe is inherently problematic. In one embodiment of a two phase measuring apparatus, light introduced into a filled tube will reflect only or predominantly at the junction of the fiber and its refractive index, as it passes into the fluid and its refractive index. An additional reflective junction will be present at the surface of the liquid 75 when air is present in pipe 47. A much greater reflection will occur at the end of the fiber when the tube 47 is partially filled, and a further reflection will occur at the junction of the air and liquid 75 interface within the tube 47. Thus, any gravitationally induced volume of air in the tube 47 will register a significant reflection in any fiber optic transmission structure regardless of whether it is thin line 55 or solid fiber optic line 117.

A similar arrangement could be used where a drainage pipe is vertical, but where a more sensitive change in refractive index is used, or where some mode of reflection or absorption of light against the opposite pipe wall is utilized. A horizontal drainage pipe would function much more efficiently in an indication of complete outage, as there is no level in the main reservoir 31 to hold liquid 75 below such a bottom mounted tap. In this instance, a flashing “out of product” indicator would save users from the temptation to try the operating handle 53 in vain. In the case of the horizontal pipe 47, and depending upon the depth of the main reservoir 31 below the pope 47, users might be able or tempted to tilt the container 11 forward to obtain the last bit of liquid 75. The indications in the display area 63 can discourage this by showing “empty” and possibly help reduce mishaps from attempts at tilting the container 11. Thus, the indicator system 71 can decrease the incidences of tampering by non-authorized personnel and reduce mishaps.

In yet another alternative, a pressure cell 121 can be mounted inside the main horizontally disposed drainage pipe 47, with a transmission wire set 123 leading back to the sensor processing circuit 87. An internally mounted pressure cell 121 would preferably be self contained, with a surface exposed which is not in the way of flow, and which is somewhat remote from experiencing force. Pressure cell 121 is shown on the bottom of main horizontally disposed drainage pipe 47 but could be located anywhere about its circumference, or indeed anywhere in as close of a proximity as practicable in contact with the lower most liquid 75 to gather the static head pressure efficiently.

Referring to FIG. 3, a closeup view of one embodiment of the display area 63 is seen. A central upper area includes a vertical stack of horizontal bars 131 which individually illuminate to reflect the liquid 75 level within the main reservoir 31. It is important to have an indicator which can be instantly interpreted by workers of all languages, and this is the case for display area 63. Vertical stack of horizontal bars 131 may preferably be green in color and indicate either the complete range of fill, or may indicate the top 80% of fill to indicate to food service workers that the level may be getting low, but should be watched.

Below the vertical stack of horizontal bars 131 is a second area of diminishing shapes 133. The shapes 133 may be red in color and indicate a series of levels within the last 20% of the range of the liquid 75 level within the main reservoir 31. To the left side of the display area 63 is a first hourglass shaped stack of horizontal bars 135. The upper set of bars 135 may be green and the lower one or two may be red. As a timer, the bars 133 can indicate the progression of time during which the liquid 75 has been present within the main reservoir 31.

A second hourglass shaped stack of horizontal bars 137 is located to the right, and may flash red at different rates to indicate an emergent need to replace the liquid 75. Where the sensor processing circuit 87 is programmed to cumulate a growing need for replacement of the liquid 75, the triggering of a second hourglass shaped stack of horizontal bars 137 might occur not based upon just one extreme, such as the falling level of liquid 75 within the main horizontally disposed drainage pipe 47 to the extent that there is an air gap, but perhaps earlier based upon a combination of time and low liquid level.

For example, second hourglass shaped stack of horizontal bars 137 might trigger a flashing change indication where the temperature was only 80% of the acceptable fall in temperature and where the passage of time was 80% of the critical time passage. This combinational decision to render an change product alarm which is more sensitive than either of the two scalar progressions might also result in a different flashing rate.

Where the flash rate is proportional to the extremity of measured liquid 75 level and temperature circumstances, food service workers could be instructed to replace the liquid 75 at the slowest rate of flash (quickest circumstances) or to wait until the most rapid rate of flash (for slowest terminal circumstances) told to replace the product at a lesser be adjustable based upon business dictates. For example, in a hotel where a buyer has purchased only a single container of liquid 75, workers would know to remove the liquid dispensing container 11 at the highest rate of flash. Conversely, where a customer demands only the freshest, hottest product over a given time period, food workers would be alerted to replace the product early in the dispensation cycle, without waiting for outages. This causes a proper increase in sales based upon the quality level demanded. Where high quality product is demanded, the failure in supplying it is a failure in service. As a result, the indicator system 71 helps prevent inadequate service.

The level of visual indication to the food service worker can be modulated by colors, flashing, increased brightness or other indication. Further, sensor processing circuit 87 may include an on board electromagnetic communications capability to send a signal back to a central station. The signal can include each of the individually measured parameters of time, temperature, level and two-phase bottomed out depletion, or the logic for sending a signal based upon a combinational threshold based upon any number and degree of the time, temperature, level and two-phase bottomed out depletion can be formulated by the sensor processing circuit 87.

In such a system in a convention center, for example, a central computer would be receiving signals from a series of food service liquid dispensing containers 11, typically coffee pots, in the center's facility. Where certain customers only purchased a single pot, signals from the container 11 would not result in a response. Where another customer had request a high level of service, the computer would detect by radio, a threshold condition and might immediately notify the food service worker by hand-held radio, or by a pager system directing the worker to replace the container 11 immediately.

Further, in rooms which are busy, and which are of such high priority to have a worker assigned to be present during the event, the central system could be disabled as to that room, relying instead upon a much more immediate visual detection and a much quicker replacement of food product than would be obtainable with distributed information management and control through a computer and paging system.

It is preferable for all of the components seen in FIG. 2, with the exception of the main reservoir to be supplied as an integral unit. In the construction of original equipment, assembly time will be significantly reduced by having to merely perform the simple step of inserting the tap 43 and attached sensor housing 61 assembly into the main reservior 31 and forming a fluid tight connection. In terms of retrofit, the provision of a tap 43 and attached sensor housing 61 assembly with the double flange fitting 45 replaced by a unit with a large threaded continuation of fitting 45 and a large nut for engagement of the threaded continuation, would facilitate change out of conventional taps 43 with complete tap and sensor sets in a manner so simple as to enable ordinary user to make the change out.

In terms of power management, when the reservoir is empty or has not undergone a change in some time, the display 63 and sensor processing circuit 87 may be programmed to attain a sleep/non-functioning mode, to save battery 91 energy. As the sensor processing circuit 87 detects that the main reservoir 31 has started to become filled and a pressure increase is sensed, the sensor processing circuit 87 will wake up and start to display.

The sampling rate for the sensor processing circuit 87 may be from 1-30 seconds. This will preclude the display from “jumping” as the server is being filled, and will further save energy. Once the sensor processing circuit 87 detects that a level is stable or not increasing for a period of about two minutes or greater it will start recording time as an indication of product freshness. A center portion or gray bar of the timer indicator in the display area 63 may start flashing to indicate that timing is started. Each horizontal line may be a time increment, such as a 15 minute increment where it is desired that food service workers are able to monitor the temporal progress.

Once a desired time increment is timed out the upper bar will be empty and the lower one will remain solid. This “hour glass effect” provides and intuitive time display for product freshness in the server. There may be 1-4 timers displayed. As each full timer is times out, about one hour, the next timer will appear on the display. When the server is empty and the transducer senses it will shut off the timers and not display any horizontal bars in the display area 63.

If the liquid dispensing container 11 is being pre-heated by filling with liquid (such as to pre-heat with a hot liquid or pre-chill with a cold liquid) and then dumped out it may inadvertently start the level and timer. However once the pre heating or cooling liquid is dumped, and where the sensor processing circuit 87 is so programmed, the liquid dispensing container 11 will reset to zero and wait to start again on another fill cycle.

In a further embodiment of an even more accurate and even more easily readable system, a more compact and unitary assembly can be provided to give the most fundamental and easy to read indication system which serves an advantage of facilitating retrofit and in requiring the minimum time to train food service workers and in giving the most accurate level readout at low volumes.

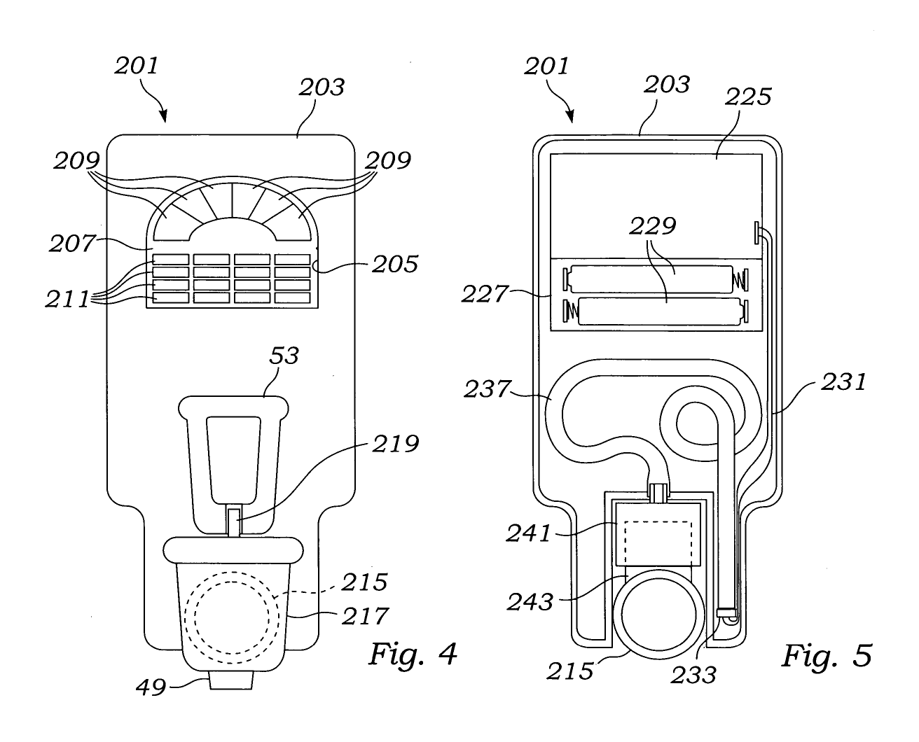

Referring to FIG. 4, a housing and spigot assembly 201 is seen. The housing and spigot assembly 201 has a housing 203 having an opening 205 as a window on a display 207 which may be a liquid crystal display. Display 207 may preferably have a number of features, and in particular two predominant features shown in FIG. 4, including a level feature seen as a set of upper radial arced segments 209 which indicate liquid level in a configuration which mimics operation of a speedometer or needle gauge. In one configuration, the arced segments 209 are divided in to six segments, with the left most segment being an “empty” indicator, and with the five arced segments 209 on the right indicating, for example, increments of 20% of full volume.

With this configuration, full illumination (or blackening in the case of a liquid crystal display) would indicate a full main reservoir 31. As the hot or cold liquid is dispensed, to a point of 80% full, the right most arced segment 209 goes off. As subsequent liquid is dispensed, the fifth, fourth third and second segments go off when the liquid level falls below 60%, 40% and 20%. The leftmost segment may be reserved for a lowest limit and may flash when the main reservoir 31 reaches the lowermost limit. Such flashing may assist in notifying food service workers.

On the display 207 below the arced segments 209 are a series of ordered rectangular segments 211. There are four rows of four segments 211 stacked in each row 211. In this one example, a four hour time period can be divided evenly into sixteen fifteen minute segments. The first row can represent the first hour, the second row can represent the second hour, the third row the third hour and the fourth row the fourth and final hour. When the filling of the main reservoir 31 is sensed, all of the segments 211 may be illuminated. The sensing of filling can be upon sensing of the liquid level rising from essentially zero level to over 20% of the main reservoir 31 level. Once filling is sensed, all of the segments 211 may be illuminated and thereafter start a count down. After fifteen minutes the uppermost right segment 211 may be turned off. After another fifteen minutes, the uppermost third segment 211 may be turned off. This continues over four hours when the left most bottom most segment 211 can be programed to shut off or to flash. With the configuration described, the food service attendant can be summoned with a flashing indicator, either as a flashing leftmost arced segment 209 upon the withdrawal of the last of the liquid from the main reservoir 31 or upon the elapsing of the last time period and flashing of the last segment 211. The indication to the food service worker can be a single flashing segment 209 or 211 or all of the segments 209 and 211 can be made to flash to make a more immediate visual indication. Further, the flashing can be augmented by other alarms, including an audible alarm, or a radio alarm communicating with the main food service facility or possibly an infrared transmitter transmitting to an infrared pickup in a serving room. The housing and spigot assembly 201 or the sensor housing 61 can provide the last link in a centralized monitoring system for food service.

As can be seen from FIG. 4, the housing 203 is seen to straddle the faucet shank (seen in phantom dashed line format) 215. The faucet shank 215 can be provided as an integral part of the housing and spigot assembly 201. In terms of providing a retrofit, the shank 215 rear side can have a fitting for engaging an existing drainage pipe 47, with or without cutting. For example, where a housing and spigot assembly 201 is provided as a retrofit to a liquid dispensing container 11 where the old spigot and valve can be removed by disconnecting a pre-existing fitting, a similar pre-existing fitting can be provided on the shank 215. Where the retrofit to a liquid dispensing container 11 where the old spigot and valve is continuous with the main reservoir 31 cannot be removed by disconnecting a pre-existing fitting, removal may be had by sawing or heat cutting. Techniques similar to those used for polyvinyl chloride piping (PVC) can be used to complete the retrofit. Other structures can be employed, such as over fitting sleeves, conical members, and other facilitative structures, as well as adhesives, glues and melting agents to complete a retrofit exchange of the housing and spigot assembly 201 for a conventional valve and spigot assembly.

In other instances, as will be shown in further detail, the housing 203 could be provided for use over existing conventional shanks if sufficient distance is provided between the main reservoir 31 and the conventional valve and its operating structures. In this case, some hole and fitting would have to be provided in the conventional shank in order to interfit and mount the housing 203 onto a conventional shank.

FIG. 4 illustrates the instance where a shank 215 is provided with the housing and spigot assembly 201, and which includes a valve 217 having an operating handle 53. Operating handle 53 operates a vertical member 219 to provide an exit from the shank 215 to a lower drain 49. This valve 217 operates by angular displacement of the operating handle 53 to pull a vertical plug to enable fluid to pass through the lower drain 49.

Referring to FIG. 5, a reverse view illustrates the components within the housing and spigot assembly 201. Near the top of the housing and spigot assembly 201, a circuit board 225 is seen slightly above a battery support 227 which supports two batteries 229. Batteries 229 may preferably be two or more “AA” sized batteries which can fit within an expected depth of the housing 203. The batteries 229 are connected to the circuit board via connectors (not shown). The circuit board 225 is also connected to a conductor set 231 which may include one, two or more conductors, fiber optics, or other information conduit connecting a pressure sensor/transducer 233 to the circuit board 225. Preferably conductor set 231 will provide enough conductors or capacity to both power and derive pressure data from the pressure sensor/transducer 233.

Pressure sensor/transducer 233 is preferably a computer chip or semiconductor having the ability to detect pressure at its location. The pressure is made available to the location of the pressure sensor/transducer 233 via a conduit 237 which is shown extending over a circuitous path possibly having non blocking kinks, loops and other extended length features. The serpentine nature is abbreviated for drafting clarity, but an actual conduit 237 should be about 2-6 times longer, and compacted within the applicable space in the housing 203 like optionally tied intestines. A longer, more serpentine conduit 237 can help make the pressure more instantly available to the pressure sensor/transducer 233 without having to provide fritted inserts, filters and the like to help isolate the pressure sensor/transducer 233 from any inadvertent contact with liquid 75. Since only static pressure is being measured, the pressure drop in the serpentine conduit 237 is negligible.

Moreover, note that pressure sensor/transducer 233 is located adjacent the centerline of the shank 215. It is preferable for the pressure sensor/transducer 233 to be located at a level between the top of the shank 215 and the bottom of the shank 215, but it is most preferable for the pressure sensor/transducer 233 to be located at the shank centerline. This enables the ambient pressure reference to be taken with respect to ambient air pressure at the lowest “effective” reservoir level. Location of the ambient pressure transducer high up can invite a significant column of liquid 75. Further, whenever the main reservoir 31 is drained, it is insured that there will be a much lesser chance that liquid 75 will be trapped.

An example of the error which is introduced when the sensor is raised above the reference point is as follows. If a sensor is mounted higher, there will be an effective vertical tube of air between a sensor and shank 215. As a further example, what if the pressure doubled in a twelve inch air column? Ideally, the air present in the column would be compressed into half the volume to indicate a doubling of the pressure. However, the material which is pushing the gas upwardly is not other gas of the same weight and density, but a liquid. In a weightless environment, the liquid would be forced up to the height of half of the twelve inch column so that the pressure would indicate a doubling. However, the column of water which would otherwise rise six inches has weight and gravity acts to pull it down. A six inch column of water, at about 62.4 pounds per square foot has a weight of about 0.43 pounds per square inch or about 0.21 pounds per square inch for a six inch column. Where a doubling of the atmospheric pressure occurred, the error in the column would be about 0.21 pounds per square inch out of the 14.596 pounds per square inch which would be a proper reading. This amounts to an error of a little less than 1.5%

However, when it is considered that a beverage reservoir operates over a range of from 1 atmosphere when empty to 1 atmosphere and say a twelve inch column when full, the error rate is more significant. In a static, closed, sealed twelve inch column, the addition of 0.43 pounds per square inch (resulting from a full reservoir) causes liquid to properly rise in a weightless environment of 0.43/14.696=about 3% or about 0.38 inches, which subtracts 0.0136 pounds from the 0.43 pounds per square inch increase or an error rate of about 3.16%.

When trying to measure for benchmarks which are 20% different, the error rate becomes relatively larger as to each benchmark. More accurate measurement introduces more relative error for larger sets of smaller benchmarks. By placing the sensor at or near the centerline of the shank 215 the ability of the error is virtually eliminated. Further, by providing a wider fitting at the shank 215, the level of rise in liquid to support a transmitted rise in gas pressure will be mitigated. As seen in FIG. 5, the conduit 237 terminates at a fitting 241 which is attached over an upwardly extending branch 243 which forms a portion of a “T” fitting with the shank 215.

The size of the fitting 241 creates a diameter which is significantly greater than the cross sectional area of the conduit 237. This enables a much lesser rise in fluid within the shank 215 for a given pressure increase transmitted through the conduit 237. The conduit 237 is preferably about one quarter inch in diameter or smaller, to give a cross sectional area of about 0.0049 square inches. The shank may be about 0.5 inches as well as the upwardly extending branch 243. 0.5 inches in diameter equals about 0.78 square inches. This ratio is about 0.78/0.0049 or about 16:1. This enables one sixteenth less fluid rise for each increase in pressure than would be the case for a single thin vertical fluid line extending upwardly from the shank 215. For any rise in liquid 75 displacing air in the conduit 237, there will be a proportional reduction in error. For the dimensions given, even if a vertical column were present (which it is not present) the error would be reduced by a factor of 16. Any other sources of error will be similarly reduced, and the configuration of FIG. 5 helps the conduit 237 remain more liquid free and to clear itself when the main reservoir 31 is dumped for cleaning.

The invention has been described with respect to a food service indicator system which replaces a sight glass on liquid dispenser food systems and including temperature and time functions to enable a higher level of food service quality. However, the techniques and structures of the invention can be applied to many similar sets of structures where level indicators, and multiple characteristics are to be taken to account in computing an alert condition, and more particularly where a need to segregate sensor and indicator function in a limited area to enable a greater unobstructed surface of equipment.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. An indicator system for potable liquid dispensing equipment comprising:
a liquid reservoir having a drainage pipe;
a valve connected to said drainage pipe for dispensing liquid;
a display;
a processing circuit having an output connected to said display; and
a pressure output transducer having a pressure connection having a first end connected to said pressure output transducer and a second end to said drainage pipe at a location between said valve and said liquid reservoir, said pressure output transducer located at a height level of said drainage pipe, said pressure output transducer having an outputted signal connection to said processing circuit, said outputted signal indicative of said pressure at said drainage pipe.

2. The indicator system as recited in claim 1 wherein said pressure connection is a fluid conduit extending between said drainage pipe and said pressure output transducer.

3. The indicator system as recited in claim 2 and further comprising a two phase fluid sensor associated with said drainage pipe and is utilized to detect the level of fluid within said drainage pipe.

4. The indicator system as recited in claim 2 wherein said pressure connection fluid conduit extending between said drainage pipe and said pressure output transducer extends upwardly from said drainage pipe and back down to said a pressure output transducer at the level of said drainage pipe.

5. The indicator system as recited in claim 1 and further comprising a temperature sensor connected to said processing circuit for measuring at least one of the temperature of fluid in said reservoir and the temperature of fluid in said drainage pipe.

6. The indicator system as recited in claim 5 wherein said temperature sensor is associated with said drainage pipe to measure a temperature of said liquid in said drainage pipe.

7. The indicator system as recited in claim 5 wherein said temperature sensor is associated with said liquid reservoir to measure a temperature of said liquid in said reservoir.

8. The indicator system as recited in claim 5 and wherein said display indicates a passage of time since said reservoir was last refilled.

9. The indicator system as recited in claim 8 and wherein said display re-sets said indication of passage of time whenever said pressure at said drainage pipe drops below and then rises above a pressure indicating that said reservoir is filled to a threshold percent of reservoir filled level.

10. The indicator system as recited in claim 9 and wherein said threshold percent of reservoir filled level is about twenty percent.

11. The indicator system as recited in claim 1 and further comprising a two phase fluid sensor associated with said drainage pipe and said sensor processing circuit to detect at least a partial absence of liquid within said drainage pipe by detecting the presence of a liquid phase and a gas phase within said drainage pipe.

12. The indicator system as recited in claim 1 and wherein said processing circuit records the passage of time, and wherein said display gives a visual indication of said passage of time.

12. The indicator system as recited in claim 10 and wherein said display indicates a combined limit threshold failure based upon a combination of said temporal limit threshold failure and said level of liquid within said liquid reservoir according to a pre-set time and liquid level combination.

13. The indicator system as recited in claim 1 and further comprising a temperature sensor associated with said pressure output transducer and connected to said processing circuit.

14. The indicator system as recited in claim 1 and wherein said pressure output transducer measures the pressure at said drainage pipe relative to ambient pressure.

15. The indicator system as recited in claim 16 wherein said drainage pipe further includes an upwardly extending branch and further comprising a fitting for providing, with said upwardly extending branch, a first expanded cross sectional area relative to a second cross sectional area of said pressure connection between said pressure output transducer and said drainage pipe.

16. The indicator system as recited in claim 1 wherein said drainage pipe, said valve, said housing, said display, said processing circuit and said pressure output connection from said drainage pipe is integrated into a single unit.

17. A retrofit indicator system for use with potable liquid dispensing equipment having a liquid reservoir and drainage pipe and comprising:
a shank for forming a part of said drainage pipe of said liquid reservoir and having a valve for dispensing liquid;
a display;
a processing circuit having an output connected to said display; and
a pressure output transducer having a pressure connection having a first end connected to said pressure output transducer and a second end to said drainage pipe at a location between said valve and said liquid reservoir, said pressure output transducer located at a height level of said drainage pipe, said pressure output transducer having an outputted signal connection to said processing circuit, said outputted signal indicative of said pressure at said drainage pipe.
